(19) United States
(12) Patent Application Publication
(10) Pub. No.: US 2017/0069399 A1
(43) Pub. Date: Mar. 9, 2017

(54) HALL EFFECT ASSISTED ELECTRON CONFINEMENT IN AN INERTIAL ELECTROSTATIC CONFINEMENT FUSION REACTOR

(71) Applicant: Apollo Fusion, Inc., Los Altos, CA (US)

(72) Inventor: Benjamin LONGMIER, Los Altos, CA (US)

(21) Appl. No.: 15/254,919

(22) Filed: Sep. 1, 2016

Related U.S. Application Data
(60) Provisional application No. 62/214,189, filed on Sep. 3, 2015.

(51) Int. Cl. G21B 1/05; G21B 1/23; G21B 1/21

(52) U.S. Cl. CPC G21B 1/05; G21B 1/21; G21B 1/23; G21Y 2002/201

(57) ABSTRACT

A fusion reactor includes a vacuum chamber, a fuel source for providing fuel to the vacuum chamber, an evacuation pump for evacuating the fuel from the vacuum chamber, a first electrode disposed in the vacuum chamber and at a chamber axis, a second electrode disposed in the vacuum chamber (which includes an aperture through which the chamber axis extends), magnets disposed in the vacuum chamber for producing a magnetic field along the chamber axis, and control electronics. The control electronics control the fuel source and the evacuation pump to provide a low pressure of the fuel in the vacuum chamber, provide a voltage to the first electrode for producing an electron beam along the chamber axis and through the aperture of the second electrode, and provide one or more voltages to the second electrode for compressing the fuel toward the chamber axis to induce nuclear fusion.

### RELATED APPLICATIONS

This application claims the benefit of U.S. Provisional Application No. 62/214,189, filed Sep. 3, 2015, and which is incorporated herein by reference.

### FIELD OF THE INVENTION

The present invention relates to nuclear fusion reactors.

### BACKGROUND OF THE INVENTION

Fusion power is the generation of energy by nuclear fusion. Nuclear fusion reactions occur when two atomic nuclei come close enough to each other for the strong nuclear force pulling them together to exceed the electrostatic force pushing them apart, which results in them fusing together into heavier nuclei. The fusion process produces heat and usually neutrons.

Researchers in nuclear fusion hope to someday use nuclear fusion reactors as a source of large scale sustainable energy. Nuclear fusion power production promises many advantages over nuclear fission power generation. One primary advantage is that, in contrast to radioactive nuclear fission waste, waste generated by nuclear fusion is short lived (decays to background levels in a relatively short time) and there is less waste produced. Another advantage is that fusion fuels are safer and easier to handle and process compared to those fuels used for nuclear fission.

Efforts to date to create such a nuclear fusion power source have failed because it currently takes more energy to initiate and contain a fusion reaction than the fusion reaction produces. Over the years, scientists have incrementally increased the efficiency of experimental fusion reactors, with hopes that someday break-even fusion will be achieved over sustained periods of time. Break-even fusion is defined as a larger amount of energy being produced compared to what is put in to produce the fusion reaction, in a steady-state way. However, current experimental fusion reactors still consume significantly more energy to generate/contain fusion reactions than is produced by the fusion reaction. Additionally, existing fusion reactor designs are large and costly (some exceeding billions of dollars of up front capital expenditure).

There is a need for an improved nuclear fusion reactor and nuclear fusion techniques that increase the energy produced from fusion reactions versus the energy consumed to create and sustain fusion reactions, so that one day break-even fusion as an energy source becomes a reality.

### BRIEF SUMMARY OF THE INVENTION

The aforementioned problems and needs are addressed by a fusion reactor that includes a vacuum chamber (having inlet and outlet ports, and having a chamber axis), a fuel source connected to the inlet port for providing fuel to the vacuum chamber, an evacuation pump connected to the outlet port for evacuating the fuel from the vacuum chamber, a first electrode disposed in the vacuum chamber and at the chamber axis, a second electrode disposed in the vacuum chamber (wherein the second electrode includes an aperture through which the chamber axis extends), one or more magnets disposed in the vacuum chamber for producing a magnetic field along the chamber axis, and control electronics. The control electronics are configured to control the fuel source and the evacuation pump to provide a low pressure of the fuel in the vacuum chamber, provide a voltage to the first electrode for producing an electron beam along the chamber axis and through the aperture of the second electrode, and provide one or more voltages to the second electrode for compressing the fuel toward the chamber axis to induce nuclear fusion.

A method of inducing nuclear fusion includes placing a gaseous fuel in a vacuum chamber (wherein the vacuum chamber includes a second electrode therein having an aperture), generating an electron beam in the vacuum chamber that passes through the aperture of the second electrode and ionizes the gaseous fuel, providing a magnetic field along the electron beam, and providing one or more voltages to the second electrode for compressing the fuel to induce nuclear fusion.

Other objects and features of the present invention will become apparent by a review of the specification, claims and appended figures.

### BRIEF DESCRIPTION OF THE DRAWINGS

FIG. 1 is a side cross sectional schematic view of the fusion reactor of the present invention.

FIG. 2 is a top view of the second electrode of the present invention.

FIG. 3 is a schematic diagram of the control electronic components for generating the high voltage pulses for second electrode 20.

FIGS. 4A-4G illustrate alternate embodiments of the second electrode.

### DETAILED DESCRIPTION OF THE INVENTION

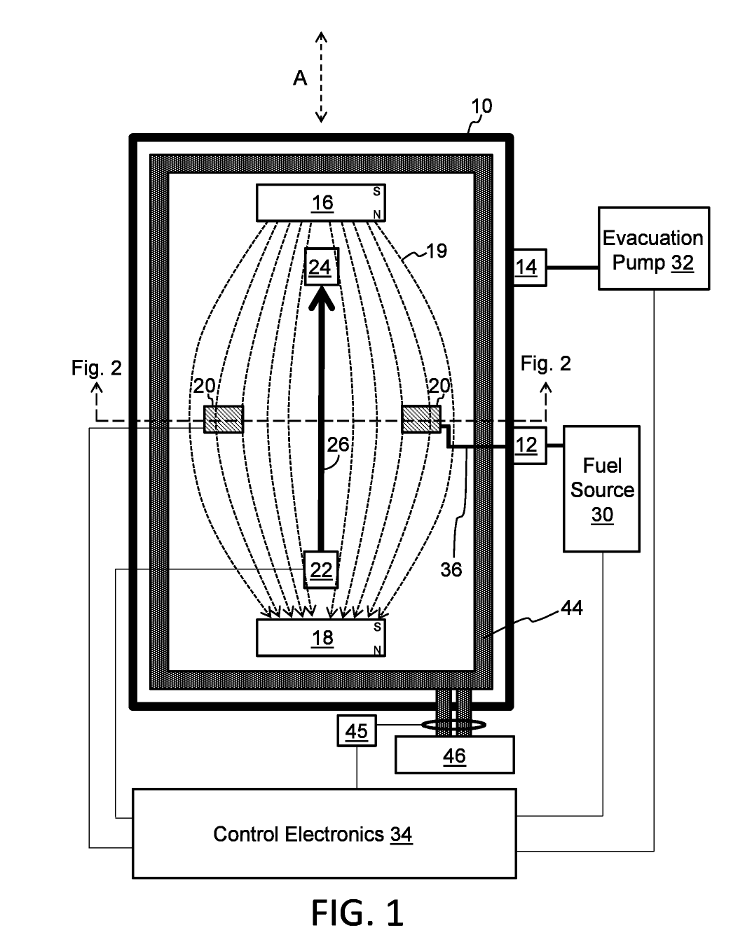

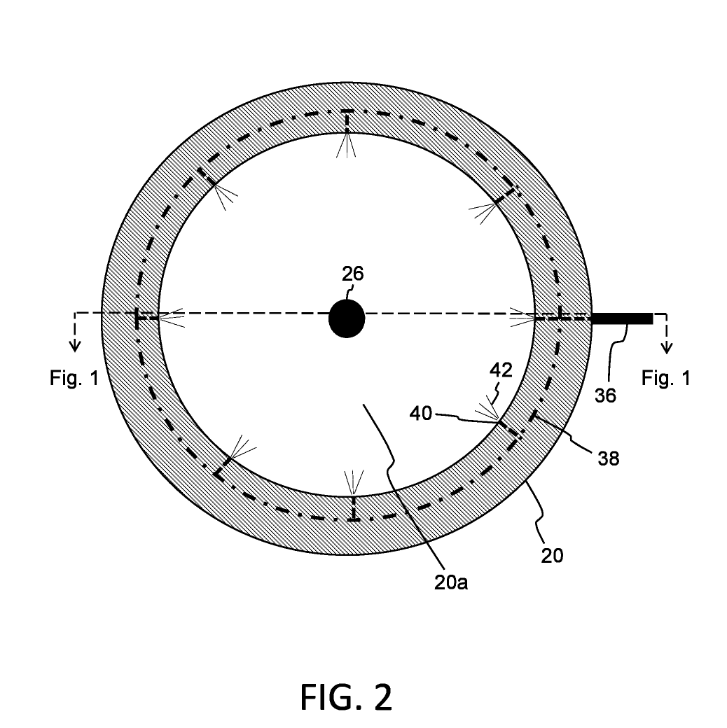

FIGS. 1 and 2 illustrate the Hall Effect Assisted Thermonuclear (HEAT) fusion reactor 1 of the present invention. The reactor 1 includes a containment vacuum chamber 10, a gas inlet port 12, one or more evacuation ports 14, permanent magnets 16/18, an annular second electrode 20, and an electron beam first electrode 22. First electrode 22 creates an electron beam 26 down the axis A of the chamber, through the center of second electrode 20, and to a quartz plate 24 or other dielectric surface (which absorbs or reflects the electrons). Fuel source 30 supplies (in a metered, controlled fashion) gaseous fuel to the chamber 10 via port 12. An evacuation pump 32 removes the unused and consumed fuel (and any contaminates) from the chamber via port 14. There could be a plurality of evacuation pumps 32 and/or ports 14. Fuel source 30 can include a tank containing the fuels and a gas flow controller to control the flow of gas into the chamber 10. Fuel source 30 and evacuation pump 32 together regulate net fuel intake and evacuation to and from the chamber 10 to maintain a low pressure of the fuel (e.g. 10⁻¹⁰ Torr static and 10⁻⁵ Torr hot/running). The preferred fuel is an even mixture of deuterium+tritium, however other fuel combinations work as well (deuterium alone, deuterium+helium-3, proton+boron-11, etc.). Control electronics 34 control the various electronic components of the system (i.e., provide voltages/currents and/or drive signals to the electron beam first electrode 22 for producing the desired electron beam 26, the second electrode 20, the pump 32 and the fuel source 30).

It is desirable to direct the incoming fuel to the center of the second electrode 20, where fusion efficiency will be the highest. Therefore, a supply line 36 directs the input fuel from inlet port 12 to the second electrode 20, which includes channels 38 formed therein that terminate in openings 40 facing the center of second electrode 20. The channels 38 and openings 40 direct the incoming fuel toward the center of second electrode 20, as illustrated in FIG. 2.

In operation, a beam of electrons 26 is created down the center of the chamber from first electrode 22 (emitting electrons) to plate 24 (receiving the emitted electrons). This electron beam 26 forms a virtual cathode for the reactor, which avoids a physical cathode element at the point of the fusion reaction that can wear and contaminate the chamber 10. Impurities decrease fusion efficiencies and reaction rates. The electrons near the second electrode 20 collide with the fuel particles, knocking off electrons and creating a plasma of the fuel atoms or molecules. Plasma is an electrically-charged gas in which the negatively charged electrons in atoms are separated from the positively charged atomic nuclei (or ions). The electron beam creates a high density plasma of the fuel particles in volume interior to the second electrode 20 and between magnets 16 and 18.

A high positive voltage is placed on the second electrode 20 to compress the positively charged ions in the plasma toward the electron beam. The electrons in beam 26 are attracted to the high voltage on second electrode 20. Therefore, magnetic field 19 from magnets 16/18 provides a resistance for the electrons to the second electrode 20, and therefore maintains most of the electrons in beam 26 as the beam passes through the center of second electrode 20. It is undesirable to have the magnitude of the magnetic field strength be too high, as that would prevent the ions from being focused at the center of the second electrode 20. It is also undesirable to have the magnitude of the magnetic field strength be too low, as the electron beam 26 would be insufficiently maintained. A balanced magnetic field magnitude is preferred, which is sufficient to maintain most of the electron beam 26 down the center of the device (i.e., some of the electrons may escape the beam 26 and make it to second electrode 20), yet will not prevent the ions from being focused at the center of second electrode 20.

The combination of the virtual cathode in the form of an electronic beam that ionizes a tightly focused line of fuel particles, and the high positive voltage on second electrode 20 that further compresses the tightly focused line of fuel particles at the center of second electrode 20, as maintained by the balanced magnetic field 19 from magnets 16/18, creates an environment where nuclear fusion occurs. In this high energy environment, a percentage of the colliding particles will undergo fusion, which causes the nuclei to fuse together and emit neutrons.

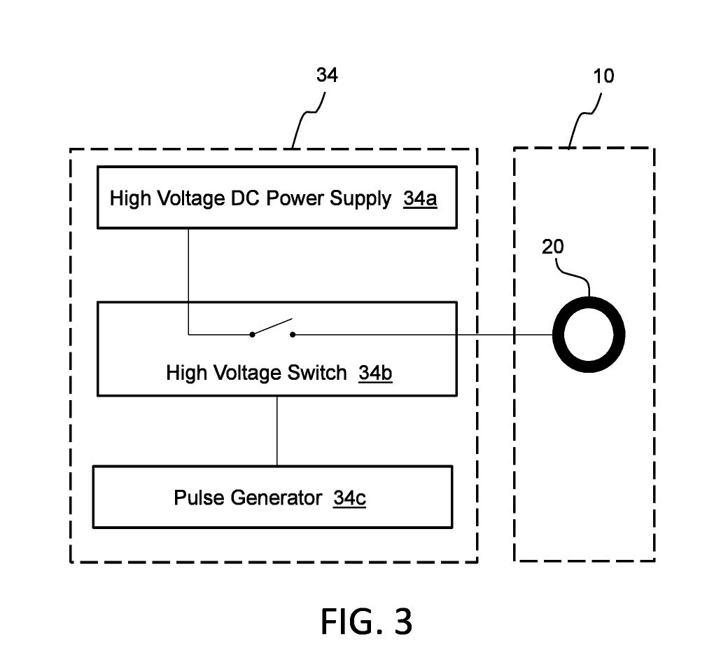

It has further been discovered that pulsing the voltage on second electrode 20 compresses even further the ionized particles to even a smaller spot (i.e. smaller area of confinement with much greater particle heat and energy than achievable using a constant voltage on second electrode 20). Specifically, plasma density can be increased by a factor of 700 times or more than that achieved without pulsing the voltage on second electrode 20. Because fusion yield is proportional to the square of the plasma density, a significant increase in fusion yield is achievable by the combination of virtual cathode, balanced magnetic field, and pulsed second electrode voltage. These high voltage pulses can be generated by a high voltage DC power supply 34a, a high voltage switch 34b and a pulse generator 34c driving the switch 34b, as shown in FIG. 3.

The fusion reaction of deuterium and tritium produces neutrons, which are emitted from the fusion site at or near the center of second electrode 20. The inside of the vacuum chamber 10 is lined with a manifold 44. A neutron capturing material (e.g. molten salt—FLiBe) circulates through the manifold 44 under pressure of pump 45 and out to an energy converter 46 (e.g. heat exchanger, steam turbine system, etc.) from which the thermal energy generated by the captured neutrons can be extracted as generated power. If the fuel produces just heat and not neutrons (i.e., aneutronic reactions such as deuterium+helium, proton+boron, etc.), then heat capturing material (e.g. water) can be circulated through manifold 44.

The HEAT fusion reactor 1 has many advantages. The electron beam 26 ensures that the virtual cathode is a small total volume, which increases the compression ratio for ions into a small fusion core at the center of the device. This small virtual cathode volume acts to increase the fusion core plasma density and to increase the fusion rate. The balanced magnetic field provides a resistance to electron motion directly to the second electrode 20, effectively reducing the electron current to the second electrode 20, which helps to reduce x-ray losses from electron-to-second-electrode impacts. The magnetic field also helps confine most of the electrons near the center of the fusion reactor but allows for the higher energy electrons to escape (where these higher energy electrons would normally emit excess x-ray radiation). The ions are not magnetized, so they are not affected directly by the magnetic field. The ions are only affected by the electric fields within the fusion reactor that are present because of the second electrode, virtual cathode, and limited electron mobility. The HEAT reactor is fuel choice agnostic, and removes many of the early problems faced with earlier inertial electrostatic confinement fusion devices such as material sputtering of the electrodes and low overall fusion rates. The HEAT reactor has a simple design that can be manufactured with a small size and low cost.

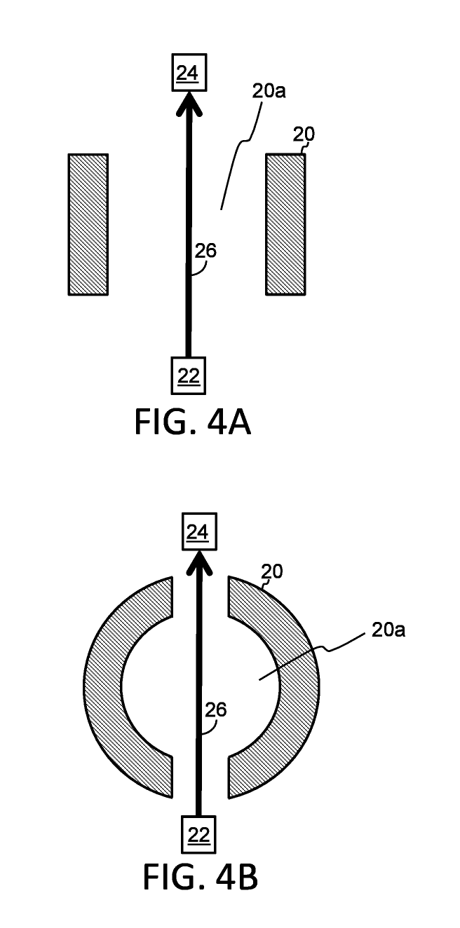

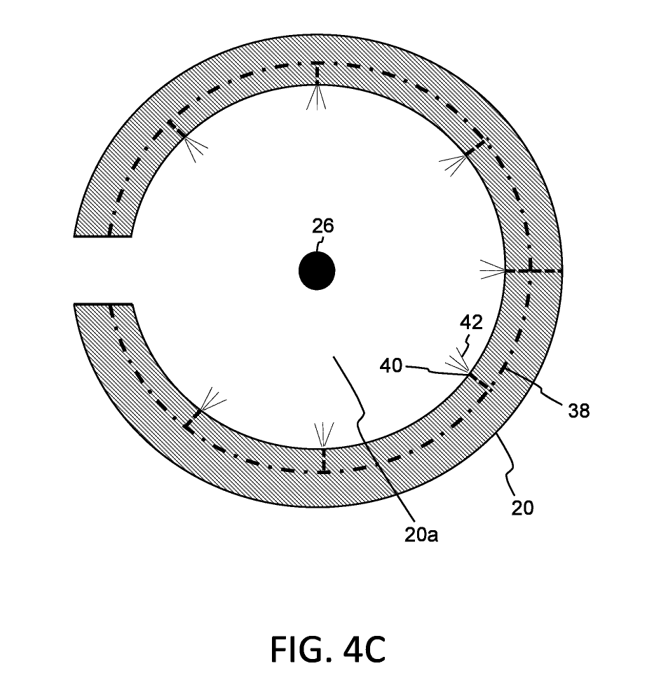

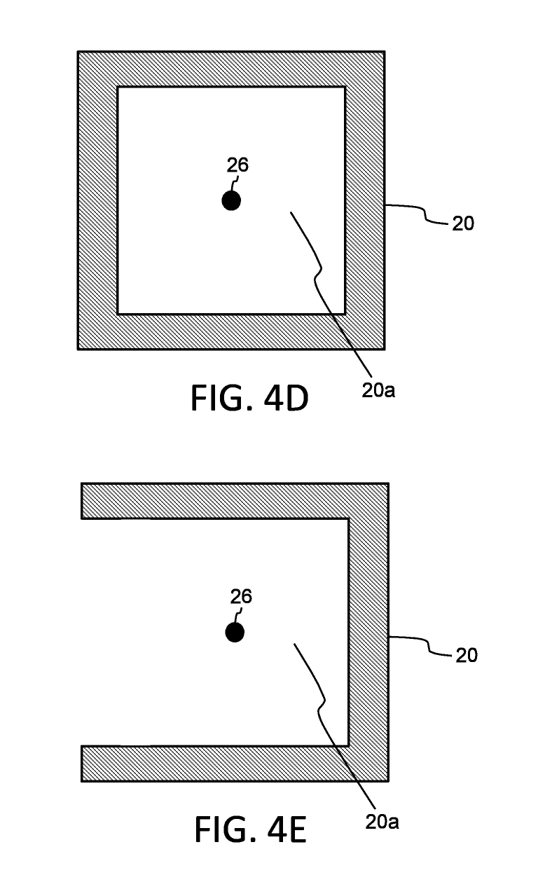

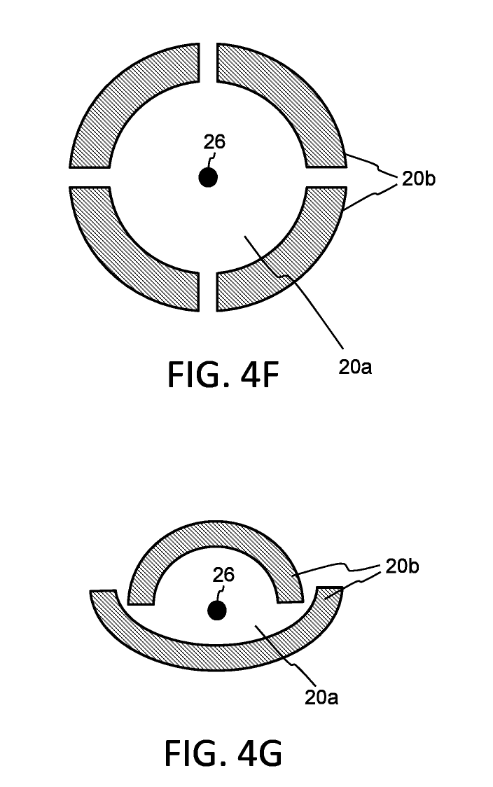

While second electrode 20 is preferably ring-shaped, symmetric and unitary, defining an aperture 20a through which the electron beam passes that is circular and enclosed in cross section, it need not be. The second electrode 20 could define other aperture shapes, such as cylindrical, spherical, spheroid, etc. For example, FIG. 4A illustrates second electrode 20 defining a cylindrical shaped aperture 20a extending lengthwise along the electron beam 26. The cylindrical shape can be solid as shown, could include holes for specially shaped electric fields, or even could include a spiral slot so the second electrode has a cork screw shape. FIG. 4B illustrates second electrode 20 defining a spherical shaped aperture 20a. Additionally, the aperture 20a need not be fully enclosed (i.e. aperture 20a not fully enclosed at its perimeter because of a gap, slot or other void in the second electrode 20), as shown in FIG. 4C. The second electrode 20 need not be equidistant at all points from the electron beam as shown in FIG. 4D, or symmetric around the electron beam 26 as shown in FIG. 4E. The second electrode 20 can comprise separate segments 20b (i.e. not unitary) that define aperture 20a that is not fully enclosed, as shown in FIG. 4F. The segments 20b can be spaced at different distances from the electron beam 26 and or have different shapes, as shown in FIG. 4G. The segments could have different spacing from electron beam 26 and along electron beam 26. An advantage of a second electrode 20 with multiple segments 20b is that different voltages can be applied to the various segments 20b to achieve the desired ion compression.

While high fusion efficiencies have been achieved using a high positive voltage placed on the second electrode 20, it is also possible to achieve fusion using a negative voltage on the second electrode 20. For example, the first electrode 22 (and hence the electron beam 26) would still be referenced to ground potential (0 V). A negative voltage can be applied to the second electrode 20 as a pulse. When the pulse is off, the second electrode 20 is at ground potential (0V). When the second electrode is on (high negative potential), it would form a plasma next to the interior surface of the second electrode 20, where the electrons formed from this plasma would accelerate towards the electron beam 26. Most of the ions formed in this plasma would then be collected by the second electrode 20 itself. Both the outgoing electrons and the incoming ions would show up as a current on the second electrode 20. Because of the high concentration of electrons in the electron beam, and because of the electrons being focused from the second electrode 20 towards the electron beam 26, a negative potential well would develop. This negative potential well would attract ions into the well. Some of these ions would come from the plasma formed near the second electrode 20, and some of these ions would come from the diffuse plasma in the volume interior to the second electrode 20. When these ions fall into this negative potential well, they can gain enough energy to result in fusion.

It is to be understood that the present invention is not limited to the embodiment(s) described above and illustrated herein, but encompasses any and all variations falling within the scope of any claims. For example, references to the present invention herein are not intended to limit the scope of any claim or claim term, but instead merely make reference to one or more features that may be covered by one or more of the claims. Materials, processes and numerical examples described above are exemplary only, and should not be deemed to limit the claims. Further, as is apparent from the claims and specification, not all method steps need be performed in the exact order illustrated or claimed. Control electronics could be a centralized set of control circuits and voltage supplies (with common user interface controls), or could be separate and distinct control circuits and voltage supplies (with separate user interface controls) for each of its functions.

What is claimed is:

1. A fusion reactor, comprising:
a vacuum chamber including inlet and outlet ports, and having a chamber axis;
a fuel source connected to the inlet port for providing fuel to the vacuum chamber;
an evacuation pump connected to the outlet port for evacuating the fuel from the vacuum chamber;
a first electrode disposed in the vacuum chamber and at the chamber axis;
a second electrode disposed in the vacuum chamber, wherein the second electrode includes an aperture through which the chamber axis extends;
one or more magnets disposed in the vacuum chamber for producing a magnetic field along the chamber axis; and
control electronics configured to:
control the fuel source and the evacuation pump to provide a low pressure of the fuel in the vacuum chamber,
provide a voltage to the first electrode for producing an electron beam along the chamber axis and through the aperture of the second electrode, and
provide one or more voltages to the second electrode for compressing the fuel toward the chamber axis to induce nuclear fusion.

2. The fusion reactor of claim 1, wherein the one or more voltages are one or more positive voltages.

3. The fusion reactor of claim 1, wherein the one or more voltages are one or more negative voltages.

4. The fusion reactor of claim 1, wherein the one or more voltages are pulsed.

5. The fusion reactor of claim 4, wherein the control electronics comprise:
a power supply for generating the one or more voltages;
a pulse generator for generating a pulsed control signal; and
a switch for intermittently connecting the one or more voltages to the second electrode in response to the pulsed control signal.

6. The fusion reactor of claim 1, wherein:
the second electrode comprises a channel formed therein terminating in openings at the aperture, and
the fusion reactor further comprises a gas supply line connected between the inlet port and the channel of the second electrode.

7. The fusion reactor of claim 1, further comprising:
a manifold disposed in the vacuum chamber;
an energy converter disposed outside of the vacuum chamber; and
a pump for circulating energy capturing material through the manifold, and to and from the energy converter;
wherein the energy converter is configured to extract energy from the energy capturing material.

8. The fusion reactor of claim 1, wherein the energy capturing material is molten salt.

9. The fusion reactor of claim 1, wherein the second electrode is ring shaped and unitary.

10. The fusion reactor of claim 1, wherein the second electrode is cylindrically shaped.

11. The fusion reactor of claim 1, wherein the aperture is not fully enclosed.

12. The fusion reactor of claim 1, wherein the second electrode comprises a plurality of separate segments.

13. The fusion reactor of claim 12, wherein the controller is configured to provide a first of the one or more voltages to one of the plurality of separate segments and a second of the one or more voltages to another of the plurality of separate segments, and wherein the first of the one or more voltages is different than the second of the one or more voltages.

14. The fusion reactor of claim 1, wherein the fuel includes at least one of deuterium, deuterium+tritium, deuterium+helium-3, and proton+boron-11.

15. A method of inducing nuclear fusion, comprising:
placing a gaseous fuel in a vacuum chamber, wherein the vacuum chamber includes a second electrode therein having an aperture;
generating an electron beam in the vacuum chamber that passes through the aperture of the second electrode and ionizes the gaseous fuel;
providing a magnetic field along the electron beam;
providing one or more voltages to the second electrode for compressing the fuel to induce nuclear fusion.

16. The method of claim 15, wherein the one or more voltages are one or more positive voltages.

17. The method of claim 15, wherein the one or more voltages are one or more negative voltages.

18. The method of claim 15, wherein the one or more voltages are pulsed.

19. The method of claim 15, wherein:
the second electrode comprises a channel formed therein terminating in openings at the aperture, and
the placing of the gaseous fuel includes injecting the fuel through the channel and out the openings at the aperture.

20. The method of claim 15, further comprising:
capturing energy from the nuclear fusion in energy capturing material disposed in a manifold in the vacuum chamber;
circulating the energy capturing material between the manifold and an energy converter disposed outside of the vacuum chamber; and
extracting energy from the energy capturing material in the energy converter.

21. The method of claim 15, wherein the second electrode is ring shaped and unitary.

22. The method of claim 15, wherein the second electrode is cylindrically shaped.

23. The method of claim 15, wherein the aperture is not fully enclosed.

24. The method of claim 15, wherein:
the second electrode comprises a plurality of separate segments;
the providing of the one or more voltages to the second electrode comprises providing a first of the one or more voltages to one of the plurality of separate segments and a second of the one or more voltages to another of the plurality of separate segments; and
the first of the one or more voltages is different than the second of the one or more voltages.

25. The method of claim 15, wherein the fuel includes at least one of deuterium, deuterium+tritium, deuterium+helium-3, and proton+boron-11.
